(19) United States
(12) Patent Application Publication
(10) Pub. No.: US 2013/0021446 A1
(43) Pub. Date: Jan. 24, 2013

(54) SYSTEM AND METHOD FOR ENHANCED SENSE OF DEPTH VIDEO

(71) Applicants: Guy RAZ, Rehovot (IL); Thomas A. Seder, Northville, MI (US); Omer Tsimhoni, Raanana (IL)

(72) Inventors: Guy RAZ, Rehovot (IL); Thomas A. Seder, Northville, MI (US); Omer Tsimhoni, Raanana (IL)

(73) Assignee: GM GLOBAL TECHNOLOGY OPERATIONS LLC, Detroit, MI (US)

(21) Appl. No.: 13/186,732

(22) Filed: Jul. 20, 2011

(51) Int. Cl. H04N 13/02

(52) U.S. Cl. 348/47; 348/E13.074

(57) ABSTRACT

A system and method receives image or video feeds from at least two cameras positioned on a platform such as a vehicle, to view a scene from different viewing points. A relative displacement between the video feeds may be selected (e.g., pre-selected, or selected by a system), and display of the feeds may be alternated on a display a chosen flicker or alternation rate, where the video feeds are displaced at the relative displacement.

### FIELD OF THE INVENTION

The present invention is related to video systems. More particularly, the present invention is related to a video system and method for enhanced sense of depth.

### BACKGROUND

Vision systems are widely used in a variety of environments. For example, rear-view vision systems in vehicles may allow a driver to view the scene behind the vehicle. Such a system typically includes a camera located at the rear of the vehicle and installed to view a scene behind the vehicle, and a display mounted on the driver's dashboard or rear-view mirror or thereabouts displaying for the driver video images of the rearward scene acquired by the camera.

Such vision systems offer two-dimensional (2D) views, thus making it very difficult at times for the viewer to properly estimate the distance from the vision system camera to various objects that are included in the viewed scene. As the primary object of a rear-view vision system for vehicles is to assist a driver in safely moving the vehicle backwards, enhancing sense of depth in the viewed scene may be a desired feature.

### SUMMARY

A system and method receives image or video feeds from at least two cameras positioned on a platform such as a vehicle, to view a scene from different viewing points. A relative displacement between the video feeds may be selected (e.g., pre-selected, or selected by a system), and display of the feeds may be alternated on a display a chosen flicker or alternation rate, where the video feeds are displaced at the relative displacement.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 illustrates a vehicle with a video system for enhanced sense of depth, in accordance with embodiments of the present invention.

FIG. 2 illustrates a method for providing a video display with enhanced sense of depth, in accordance with embodiments of the present invention.

FIG. 3 is a block diagram of a video system with enhanced sense of depth in accordance with some embodiments of the present invention.

FIG. 4a illustrates an image of a scene taken from a camera of a video system for enhanced sense of depth, in accordance with embodiments of the present invention.

FIG. 4b illustrates an image of a scene taken from a camera of the video system for enhanced sense of depth.

FIG. 4c illustrates a flickering or alternating image of the scene viewed by the video system for enhanced sense of depth, in accordance with embodiments of the present invention.

Reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However, it will be understood by those of ordinary skill in the art that the embodiments of the present invention may be practiced without these specific details. In other instances, well-known methods, procedures, components, and circuits have not been described in detail so as not to obscure the present invention.

Unless specifically stated otherwise, as apparent from the following discussions, throughout the specification discussions utilizing terms such as “processing”, “computing”, “storing”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In one embodiment, a video or moving image stream feed from each of a pair of horizontally displaced cameras may be received and alternated (shown alternatingly) in a display on a monitor shown to a driver. When the video streams are alternated, objects on or at a real-world plane (which is virtual when displayed, as it typically is not in itself displayed), which is perpendicular to the line of sight, may remain stationary as their position in the two images coordinates is the same. This stationary plane (virtual, typically not displayed) thus represents a stationary reference. When the images are alternated, for example at a “flicker rate” or alternation rate (which may be less than a video display rate of for example 30 frames per second), objects closer to the vehicle than the stationary plane (e.g., in the foreground) may move back and forth (horizontally) in one direction, objects further from the vehicle or cameras than the stationary plane (e.g., the background) may move back and forth in the opposite direction, and objects at the stationary plane may not move, or may not move substantially. Objects, both at the stationary plane and off it, may be seen also to distort or shear with proportion to their depth dimension. For example, while objects located in front of the stationary plane may move from right to left, objects located behind the stationary plane may simultaneously be observed to move from left to right. Further, the range of apparent motion may be proportional to the object distance from the stationary plane. While in one embodiment an image from each camera is alternatingly displayed with an image from the other camera, in other embodiments the video feeds may be alternated, so a number of sequential images may be displayed from one camera, and then a number of sequential images from the other camera may be displayed.

In one embodiment, the stationary plane may be defined by choosing a certain area or region in the displayed scene, or object, and displaying on the display in an alternating manner an image stream from the first camera and an image stream from the second camera, such that for each pair of subsequent image streams, the image area or region, or object is displayed in the same monitor position. After choosing the stationary image area or region or object, other real world positions or objects, when displayed, may move on a monitor or display, as described herein. Objects closer to the cameras or vehicle than the image region displayed in the same monitor position move in a first direction when the streams are alternated and objects further from the cameras or vehicle than the image region displayed in the same monitor position move in a second direction opposite from the first direction when the streams are alternated. The range of motion may indicate the distance from the image stationary plane. This may be achieved by electronically (e.g., via a video processor, or a processor executing code or instructions) displacing the pixilated images of the alternating streams horizontally, such that increased displacement moves the virtual plane further or nearer from the vehicle, depending on the cameras' line of sight configuration and displacement direction. Displacing different streams or images may be done by positioning images on the display at a certain position, where the “default” position may mean an image position based on the center, a corner, or other reference of an image, and the image position may be placed on a display at a certain display. The position for each image may be different for displaced images.

The magnitude or size of the flickering or alternating motion of an object may depend (e.g., linearly) on the object's distance from the stationary plane, allowing the observer to intuitively grasp scene depths and relative distances quickly. The initiation of flickering motion may be used to attract the attention of the driver to the rear-view monitor.

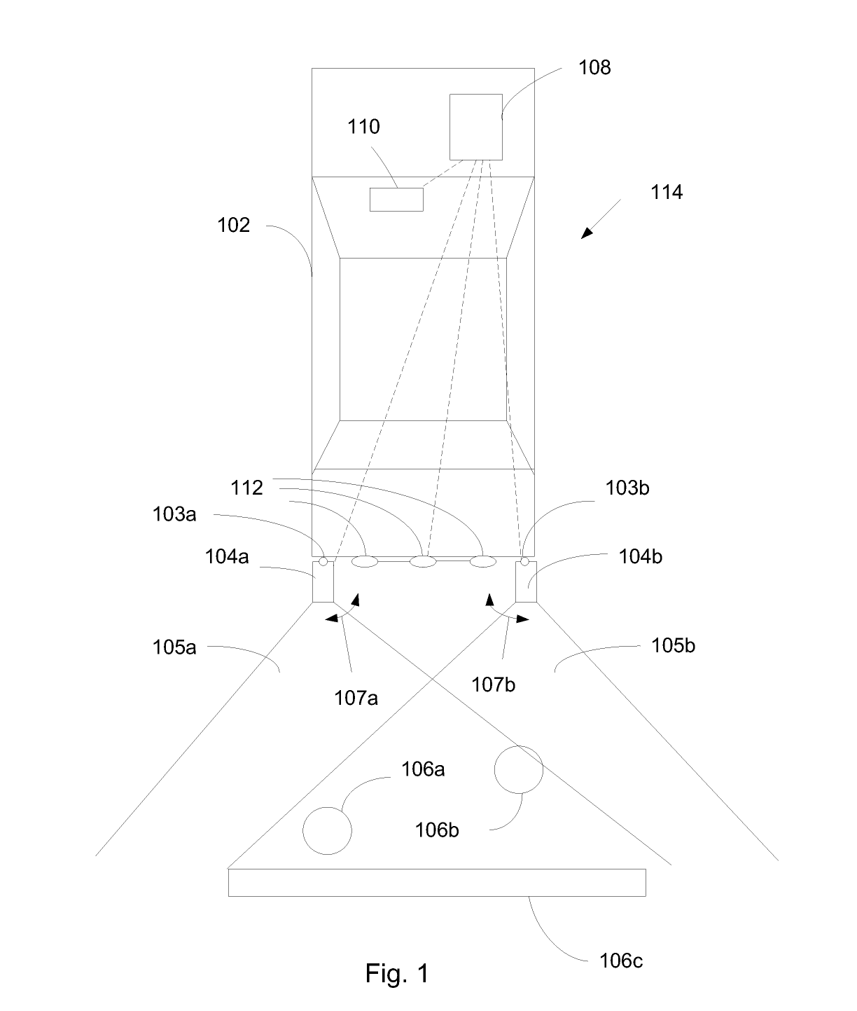

FIG. 1 illustrates a vehicle 102 with a system 114 for video display providing enhanced depth cues, in accordance with embodiments of the present invention.

In accordance with embodiments of the present invention, a system 114 for video display with enhanced depth information may include two or more cameras 104a, 104b, such as video cameras or other suitable cameras, positioned on the vehicle (or other platform) to view a scene from different viewing or vantage points, viewing angles or points of view. In order to view the scene from different viewing points the cameras are placed apart, for example, at either ends of the rear of the vehicle (e.g. at separate positions on the rear bumper, on the hood of the luggage compartment, or at other separated locations). While in one embodiment the cameras face or view the rear of the vehicle (relative to the direction of travel) in another embodiment the cameras may face forward. The scene viewed may be, for example, the scene behind the vehicle, the scene in front of the vehicle, a scene to the side of the vehicle, or another scene. Cameras 104a, 104b may be for example color cameras, black-and-white cameras, near infrared cameras, far infrared cameras, night vision cameras, or other cameras.

A “scene” viewed or imaged by the cameras may include various objects, such as, for example, posts 106a and 106b and wall 106c, all located within the overlapping fields of view, 105a, 105b, of the cameras 104a and 104b.

System 114 may also include a display device, such as, for example, video monitor or display 110. The display device may be positioned on the dashboard, on a support arm connected to the dashboard or fixed to the windshield or placed in another position to allow a driver to view the screen of the display device, while driving the vehicle. The display can also be incorporated as a head up display system (HUD), or as part of the rear-view mirror. For example, video monitor 110 may be placed in a position that allows the driver to view its screen while at the same time allowing the driver unobstructed view of the roadway ahead and its immediate surroundings.

System 114 may further include a controller 108 for receiving (e.g., live) video feeds or moving image streams from the video cameras 104a, 104b, and for feeding video monitor 110 with a flickering or alternating video feed, alternating between the live video feeds from the two video cameras at a predetermined or user controlled flicker rate or alternation.

In the flickering video feed, the live video feeds may appear to intersect or overlap at a stationary plane (typically not displayed, and thus virtual), in the viewed scene, so that when they are alternated at a predetermined rate they provide the viewer with a sense of depth which is a result of the scene appearing to slightly skew about the predetermined stationary plane. Typically the predetermined alternation or flicker rate may be within the range of 0.2-25 Hz, but many human viewers would find 3-10 Hz more agreeable and pleasant to watch. In one embodiment one or more images from the first moving image stream may be displayed, and then one or more images from the second moving image stream may be displayed; thus in one embodiment a set of pairs of images need not be displayed. For example, for a typical video rate of 30 frames per second, and a flicker rate of 10 Hz, three consecutive frames from each video stream may be displayed before switching to the other video stream.

When used herein, “stationary plane” may mean that the live video feeds are displayed alternately on the display device such that a predetermined or user controlled position in the scene that appears in both video feeds displayed at the same position on video monitor 110 (e.g., the stationary plane). When alternately displaying the video feeds the scene appears to skew about this predetermined stationary plane.

The extent of the displacement motion may depends on the distance between the cameras, the focal length of the optical set ups of the cameras and on the differences in the viewing points or angles of views.

Embodiments of the present invention may offer a relatively low-cost video display providing enhanced depth information to a viewer. The human vision system may take the enhanced depth information (e.g., the movement of objects when video streams are alternated) and produce depth interpretation.

The flickering or alternating video feed may start (e.g., transition or switch from regular or non-alternating, non-flickering video feed) upon a certain event or detection of a certain event. For example, detection of an object within a predetermined range or distance from the platform or cameras, a certain movement or threshold movement of a user's head, manual activation by a user, or a change in the context of the surroundings of the user or the vehicle (e.g., a vehicle parameter such as speed, an environmental parameter such as it being day or night, or a vehicle control setting such as a blinker on, or a gear choice). The flickering video feed may start or stop at a driver request, e.g., upon driver input to the system. Prior to such detection a normal video feed (e.g., from one of the cameras) may be displayed. This may be achieved for example by using a proximity warning or detection system 112, which may include one or several proximity sensors, for detecting an object in the vicinity of the system and in some such systems also determining the range or distance between the cameras or sensor(s) and the detected object. Controller 108 may be configured to start displaying the flickering or alternating video when detecting an object or when determining that such a detected object is found to be within a predetermined range from the sensor/s of the proximity warning system.

The flicker or alternation rate may be modifiable. In some embodiments the controller may be configured to modify, set or vary the alternation or flicker rate automatically, based on for example a detected range or distance between the object in the scene and the platform or camera, a detected distance or angle between a user head position and the display, a change in the context of the surroundings of the user (e.g., and manual selection by the user.

Controller 108 may be configured to select the predetermined stationary plane in the viewed scene (a virtual object or reference) automatically, based on object detection in the viewed scene. For example, object detection may be performed using a proximity warning system (e.g. 112 in FIG. 1), which may determine the exact position of an object in the viewed scene, and/or the distance of the object from the vehicle or cameras. Controller 108 may then set the position of stationary plane based on this information and a-priori knowledge of the view points or angles and fields of views of the cameras. This may be done by changing the relative horizontal offset or displacement between the flickering video images.

In other embodiments of the present invention image processing techniques may be applied to analyze the viewed scene and automatically select an object in the viewed scene to be the location of the stationary plane, so that when displaying the flickering video, the scene would appears to skew about that object.

In some embodiments of the present invention a manual control option may be provided in the controller for selection by a user, allowing the user to select a single video display mode displaying video from only one of the video cameras (in some of these embodiments the user may also select the camera which is to feed its video to the display device).

In the design of a system for video with enhanced sense of depth, in accordance with embodiments of the present invention, the field of view of the cameras, as well as the stereoscopic base (e.g. the distance between the cameras) and the angle between the directions of view of the cameras (e.g. the angle between their line of sight) may be chosen according to specific requirements. For example, a large semi-trailer with a wide rear may require cameras with wider field of views than cameras used for small cars.

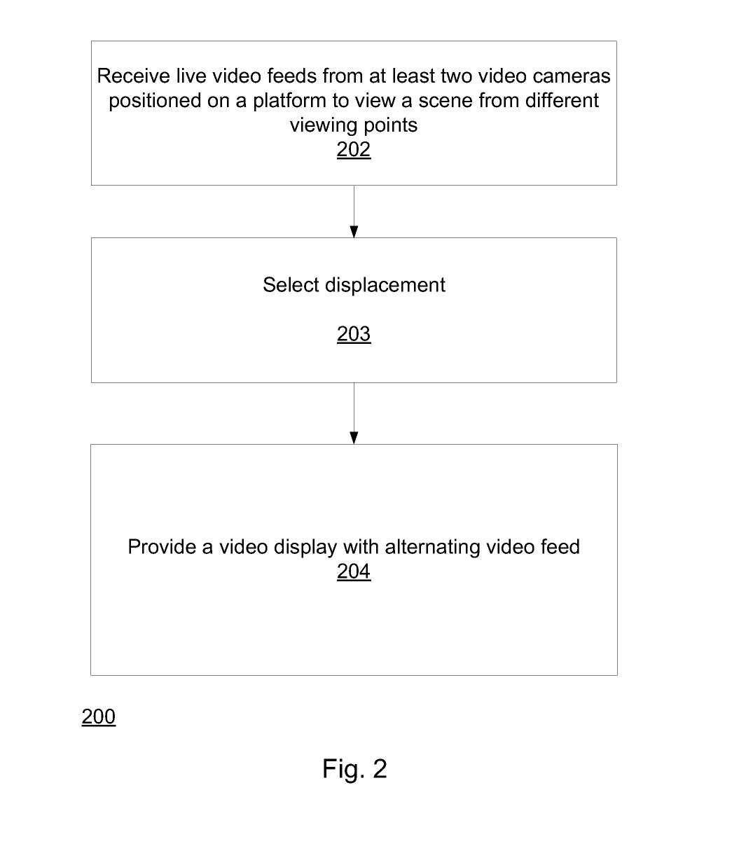

FIG. 2 illustrates a method 200 for providing video with enhanced sense of depth, in accordance with embodiments of the present invention.

In operation 202 live video feeds or streams of images may be received from at least two cameras (e.g., video cameras) positioned on a platform to view a scene from different viewing points, positions and/or angles.

In operation 203 relative displacement, offset or shift between the images or pixels of the multiple (e.g. pair) of images or video streams displayed to the viewer may be selected. The relative displacement or offset may be selected by the system, e.g., based on conditions, and/or selected by being pre-set (e.g. at manufacture). “Selecting” may include using an offset stored within the system and determined beforehand. Typically the offset of displacement is horizontal or lateral.

In operation 204 a display device may be fed or presented with a flickering or alternating video feed, alternating between the video feeds from said at least two video cameras at a predetermined flicker rate. The feeds may be displayed on the monitor displaced, e.g. horizontally displaced, from each other, by the offset or relative displacement. E.g., when an image from one steam is displayed, it may be displayed to be X pixels horizontally to the left on the monitor from the comparable position of an image from the other stream when displayed. Cropping or other techniques may keep each video stream within the same frame or border.

When displayed, objects that are on or near a virtual plane which is perpendicular or substantially perpendicular to the field of view of the cameras may not move, or may not move significantly. Objects that are further beyond the virtual plane relative to the cameras may appear to move in one direction when image streams are alternated, and objects that are closer, between the virtual plane and the cameras, may appear to move in an opposite direction when image streams are alternated.

Depending on offset direction, increasing the offset, (as long as it is not beyond the vanishing point) move the virtual plane closer or further with respect to the platform. Whether the plane moves forward or backward with an increase of offset depends in one embodiment on the relative angles of the fields of view of the cameras, e.g., the angles at which the cameras point. In the case of parallel cameras, and an offset of zero, the plane is initially at a distance of infinity. Generally, moving an offset so that images from each camera are moved towards each other, in a relative sense, on a display (even though they are typically not displayed at the same time), the plane moves closer to the cameras.

The stationary plane itself may not be displayed and thus may be virtual; rather objects may appear to move about the plane, depending on their distance from it. Images or video feeds, after being shifted, may be cropped to fit the images to a viewing frame. Typically this may be realized by software (e.g. a controller executing software instructions), as the cameras typically are located and face in a fixed position. In other embodiments of the invention the position and/or orientation of the cameras may be altered in order to assist achieving overlapping field of views. Operation 203 may have been performed before images are gathered, or may be performed periodically to, for example, alter the position of the plane.

In one embodiment of the invention, the selection of the position of the stationary plane may be carried out automatically, for example, by choosing the position of an object in the scene which is between two other objects, so that one of the other objects is in the foreground while the other is in the background with respect to the selected object. In another embodiment of the invention, the nearest (or farthest) object in the scene may be selected.

In other embodiments of the present invention, the stationary plane may be manually selected (e.g. by the user of the system, using a pointing device or another input device).

The platform may be a vehicle, and the video cameras may be positioned so as to view a scene behind or to the rear of the vehicle.

In some embodiments of the present invention the method may include starting or initiating the display the flickering video feed upon detection of an object within a predetermined range from the platform. For example, when such system is used on a vehicle for rear viewing, the system may be idle or display video from only one of the video cameras, and flickering or alternating video may be shown when the vehicle is made to move backwards (e.g. when the gear is switched to reverse) or when an object is detected in the path of the vehicle. In some of these embodiments of the present invention the method may include displaying information obtained from a proximity alarm system (112 in FIG. 1).

The flicker or alternation rate may be varied automatically, for example based on a detected range between an object in the scene and the platform. For example, the alternation or flicker rate may be slow when the range to the nearby object is large and may be faster when the object is nearer. The flicker rate may in fact be used as an additional indication for the driver of how near the vehicle is to the nearby object, where the faster the flicker rate the closer the vehicle is to the object.

In some embodiments of the present invention the method may include selecting the predetermined stationary plane in the viewed scene automatically, based on object detection in the viewed scene.

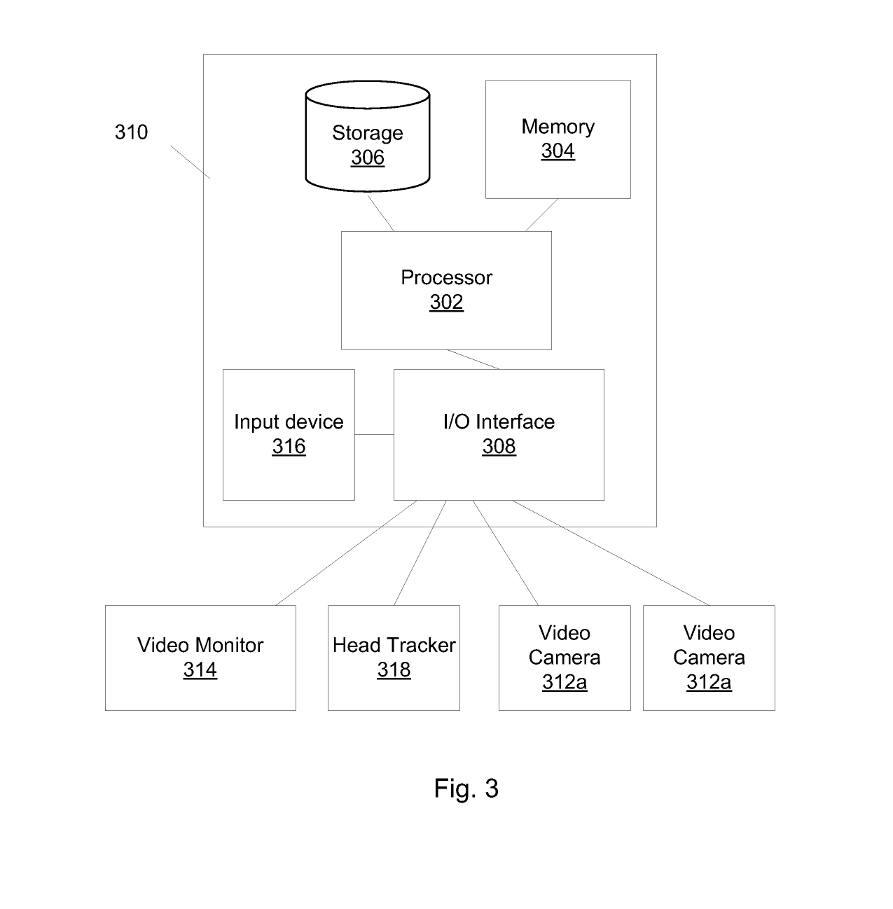

FIG. 3 is a block diagram of a video system with enhanced sense of depth in accordance with some embodiments of the present invention. System 300 may include two or more video cameras 312a, 312b, for providing live video feeds of a scene viewed from different angles of view, and video monitor 314.

Controller 310 may be provided, which may include processor 302, memory 304 and non-transitory data storage device 306. Non-transitory data storage device 306 may be or may include, for example, a random access memory (RAM), a read only memory (ROM), a dynamic RAM (DRAM), a synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Data storage device 306 may be or may include multiple memory units. Data storage device 306 may be or may include, for example, a hard disk drive, a floppy disk drive, a compact disk (CD) drive, a CD-Recordable (CD-R) drive, a universal serial bus (USB) device or other suitable removable and/or fixed storage unit, and may include multiple or a combination of such units.

Controller 310 may further include Input/output (I/O) interface 308, for interfacing the controller with cameras 312a, 312b, and video monitor 314. An input device 316 may be provided to allow a user to input data or commands.

Head tracker 318 may be provided, to track the head position of a user of the system (e.g. a driver of the vehicle). Using the head tracker 318 the distance from the vehicle or cameras to the stationary plane (e.g., the apparent distance) in the display may be modified, determined by the position of the driver's head in the cabin or passenger compartment. For example, the position of the driver's head, or distance of the driver's head from the display, may be input via a head tracker, and translated to the distance of the intersection point from the platform. Thus the driver may be able to modify the distance to the stationary plane in the display by moving his or her head towards or away from the display.

For a plane at finite distance the displayed video may be such that the objects behind the plane would move in opposite directions with respect to objects that are between the plane and the cameras. The position of the stationary plane typically depends on the initial real world offset between cameras, the initial angle between the cameras' line of sight (which can be converging or diverging), and the offset in pixels when alternating images. Physical parameters such as the initial physical offset and angles can be compensated for, for example by software offset to move the plane as desired. That the initial offset and angles may need to be known for example by knowing manufacturing tolerances or by calibration.

In one embodiment, each of the alternatingly displayed images in an image pair, or each alternating video stream or segment (one from each of a pair of cameras) is horizontally positioned or shifted on the display monitor so that objects along a virtual plane do not move substantially when the streams are alternated. This may be achieved, for example, by arranging cameras 104a and 104b (see FIG. 1) at an angle with respect to the forward direction (eg. angles 107a and 107b), for example by turning cameras 104a and 104b about axes 103a and 103b, respectively, and fixing them at the desired angles. However, the cameras may both point generally straight ahead, e.g. parallel or towards the horizon. In one embodiment, a system may include a high tolerance for the relative angles of the cameras, and the system may be calibrated (e.g., at manufacture) by having a person view the resulting feeds and calibrate a set horizontal displacement at which the plane appears to be a standard or fixed distance from the vehicle, e.g. a fixed distance across all vehicles of the same type. Thus systems having different relative angles for the cameras may still produce the same results.

Objects at the plane appear stationary in the displayed image, possibly displaying some distortion when the image display moves from one image in a pair or video stream to the other. Objects, both at the stationary plane and off it, may be seen also to distort or shear with proportion to their depth dimension. Thus, a three-dimensional illusion may be produced, aiding the user in distance estimation. Images closer to the vehicle than the plane move in one direction and images further from the vehicle move in another direction. Distance estimation may also be determined in a more accurate manner (e.g. calculated by a processor if the distance between the cameras and the plane is known. Typically, each image pair includes one image each from a video stream, or each pair of image streams includes one video segment from each of a pair of cameras. The successive display of image pairs or image stream pairs is a moving image stream or video display.

In one embodiment known image processing techniques may be used to “fix”, freeze or keep still objects in back of (further from the vehicle than) the plane, while allowing objects in front of the plane (closer to the vehicle) to move when the video feeds are alternated on the display. For example, objects displayed which are further from the cameras or vehicle than the plane (e.g., where an image region is displayed in the same monitor position when steams alternate) may not move, or may not move substantially, when the image streams are alternated.

Using image processing techniques, objects that are behind (further from the vehicle than) the plane may be artificially made to appear stationary in the displayed video, making only objects in front of the plane appear as moving in the displayed video. In such an embodiment, the system may function as an enabler for object detection by the driver for objects nearer to the vehicle than the plane. The closer the object is to the vehicle, the faster it moves, so some distance estimation, along with heightened saliency, is afforded by this method.

In one embodiment, the cameras may be mounted on the front or rear side corners of the vehicle, allowing viewing around corners. In another embodiment, a head tracker (e.g. head tracker 318, FIG. 3) may provide input to the system such that, the location of the plane may be controlled by head movement of the user. The head tracker can also be used to control which camera will present its video feed on the video monitor. Other methods of allowing user input (e.g., via input device 316) to control the distance of the plane may be used.

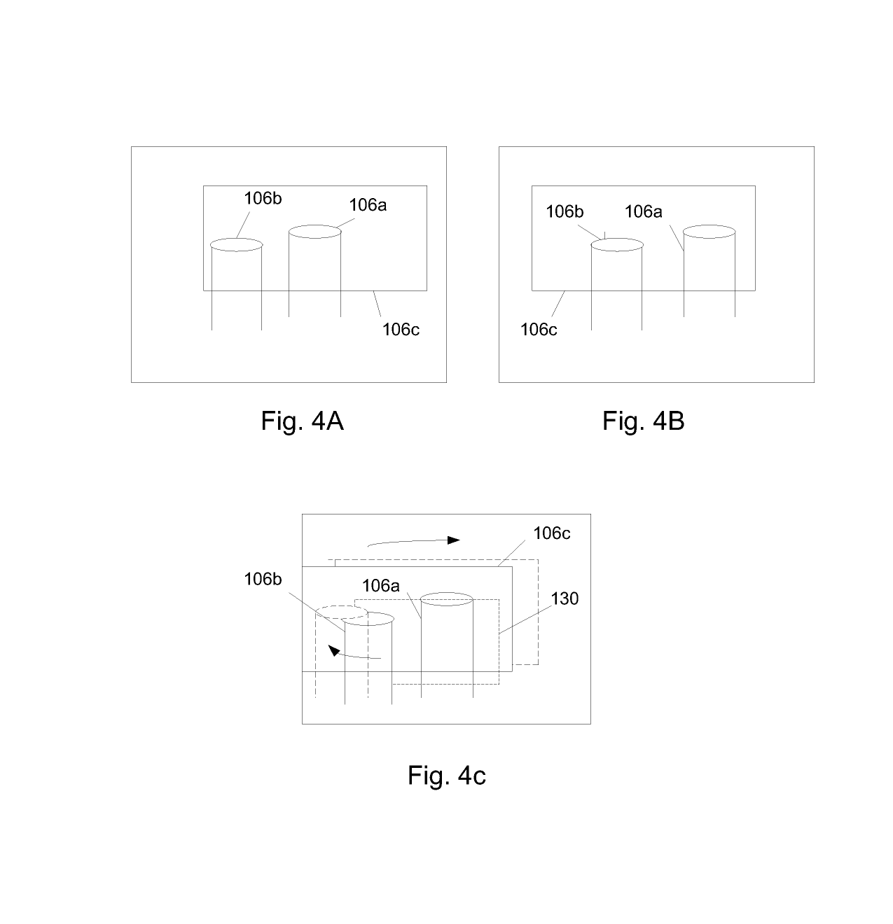

FIG. 4a illustrates an image of a scene taken from one camera of a video system for enhanced sense of depth, in accordance with embodiments of the present invention. The image shown in FIG. 4 is of the scene depicted in FIG. 1, as it was acquired by camera 104a. The scene includes an image of post 106b, which is closest to the camera among the objects depicted, an image of wall 106c and an image of another post 106b, which lies in between wall 106c and post 106a (with respect to the camera). Post 106a appears to lie at the center of the viewed scene.

FIG. 4b illustrates an image of a scene taken from another camera of the video system for enhanced sense of depth (whose other camera acquired the image shown in FIG. 4a). This image, which includes the objects shown in FIG. 4a, was acquired by camera 104b. Here post 106b appears to lie at the center of the viewed scene.

FIG. 4c illustrates a flickering or alternating image of the scene viewed by the video system for enhanced sense of depth, which is a result of alternating between the images shown in FIG. 4a and FIG. 4b, in accordance with embodiments of the present invention. Objects on or at virtual intersection plane 130 (in this example, post 106a) do not move substantially, when the streams are alternated. A virtual plane is represented in this example by a rectangle lying on the plane for clarity, but extends to the width of the viewed scene. When the video streams are alternated, the object(s) in the foreground, e.g. in front of post 106a (with respect to the camera)—namely, post 106b—appears to move horizontally (as indicated by the dashed ghost of post 106b), while wall 106c, which is in the background, appears to move horizontally in a direction opposite to that of post 106b (as indicated by the dashed ghost of wall 106c). Post 106a appears to not move.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

A processor-readable non-transitory storage medium may include, for example, any type of disk including floppy disks, optical disks, CD-ROMs, magnetic-optical disks, read-only memories (ROMs), random access memories (RAMS) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein.

Features of various embodiments discussed herein may be used with other embodiments discussed herein. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A system comprising:
at least two cameras positioned on a platform to view a scene from different viewing points;
a display device;
a controller for receiving a plurality of video feeds from the at least two cameras, and for alternating the display of video feeds on the display device at a chosen flicker rate, the video feeds displaced at a relative displacement.

2. The system of claim 1, wherein the platform comprises a vehicle, and wherein said at least two video cameras are positioned on the platform, wherein the scene viewed is selected from the group consisting of: the scene behind the vehicle, the scene in front of the vehicle, and a scene to the side of the vehicle.

3. The system of claim 1, wherein the system is configured to transition from a non-flickering display to an alternating video feed on the occurrence of a detected event, wherein the event is one of the group consisting of: detection of an object within a predetermined distance from the platform, a defined change in a user's head position, and manual activation by the user.

4. The system of claim 1, wherein the video feeds' rate of alternating is modifiable, and wherein the controller is configured to set the alternation rate based on one or more of: the detected distance between an object in the scene and the platform, detected distance or angle between the user head position and the display, change in the context of the surroundings of the user, and manual selection by the user.

5. The system of claim 1, wherein the controller is for selecting a relative displacement between the video feeds.

6. The system of claim 1, wherein the relative displacement of the video feeds is modifiable, and wherein the controller is configured to set the displacement based on one of: detected distance between an object in the scene and the platform, the detected distance or angle between the user head position and the display, and manual selection by the user.

7. The system of claim 1, wherein the displacement is horizontal.

8. The system of claim 1, wherein each of the cameras is selected from the group consisting of: a black-and-white camera, a color camera, a near infrared camera, and a far infrared camera.

9. A method comprising:
receiving a plurality of video feeds from at least two cameras mounted on a platform;
alternating the display of video feeds on a display at a chosen flicker rate, the video feeds displaced at the relative displacement.

10. The method of claim 9, wherein the platform comprises a vehicle, and wherein said at least two video cameras are positioned on the platform, wherein the scene viewed is selected from the group consisting of: the scene behind the vehicle, the scene in front of the vehicle, and a scene to the side of the vehicle.

11. The method of claim 9, comprising transitioning from a non-flickering display to an alternating video feed on the occurrence of a detected event, wherein the event is one of the group consisting of: detection of an object within a predetermined distance from the platform, a defined change in a user's head position, and manual activation by the user.

12. The method of claim 9, wherein the video feeds' rate of alternating is modifiable, comprising setting the alternation rate based on one or more of: the detected distance between an object in the scene and the platform, detected distance or angle between the user head position and the display, change in the context of the surroundings of the user, and manual selection by the user.

13. The method of claim 8, wherein the relative displacement of the video feeds is modifiable, comprising setting the displacement based on one or more of the detected distance between an object in the scene and the platform, the detected distance or angle between a user head position and the display, and manual selection by the user.

14. The method of claim 8, wherein the displacement is horizontal.

15. The method of claim 8, wherein each of the cameras is selected from the group consisting of: a black-and-white camera, a color camera, a near infrared camera, a far infrared camera.

16. A method comprising:
accepting a moving image stream from each of a first camera and a second camera, each of the first camera and the second camera positioned at a distance from the other for viewing a scene from different viewing positions, each moving image stream comprising a series of still images;
displaying on a display in an alternating manner an image stream from the first camera and an image stream from the second camera, such that for each pair of subsequently displayed image streams, each stream comprising images from one of the cameras, objects on a virtual plane substantially perpendicular to field for view of the cameras do not appear to move, and objects not on the plane appear to move.

17. The method of claim 16, comprising moving the virtual plane closer or farther from the cameras by altering a lateral offset of each pair of subsequent images when displayed.

18. The method of claim 16, wherein objects displayed which are further from the cameras than the virtual plane do not move substantially when the image streams are alternated.

19. The method of claim 16, comprising displaying a video stream from only one of the cameras and comprising displaying the images in an alternating manner upon detection of an object within a predetermined distance from the cameras.

20. The method of claim 16, wherein the rate the streams alternate is modifiable, comprising setting the alternation rate based on one or more of: the detected distance between an object in the scene and the platform, detected distance or angle between the user head position and the display, change in the context of the surroundings of the user, and manual selection by the user.
